(19) United States
(12) Patent Application Publication
(10) Pub. No.: US 2003/0084031 A1
(43) Pub. Date: May 1, 2003

(54) System and method for searching a signature set for a target signature

(76) Inventor: Richard P. Tarquini, Apex, NC (US)

Correspondence Address: HEWLETT-PACKARD COMPANY, Intellectual Property Administration, P.O. Box 272400, Fort Collins, CO, 80527-2400, US

(21) Appl. No.: 10/002,381

(22) Filed: Oct. 31, 2001

(51) Int. Cl. G06F 7/00

(52) U.S. Cl. 707/3

(57) ABSTRACT

A system and method for searching a signature set for a target signature is disclosed. The method comprises determining a hash value for a target signature; determining a branch associated with a root node of the lexical search tree data structure corresponding to the hash value, the branch along with the root node representing at least one signature of the plurality of signatures, the branch having one or more leaf nodes linked hierarchically to one another, each leaf node representing an element of the at least one signature; and traversing only the branch to find a match between the at least one signature and the target signature.

### RELATED APPLICATIONS

The present patent application is related to concurrently filed U.S. patent application Ser. No. ______, Attorney Docket No. 10017555-1, entitled “SYSTEM AND METHOD FOR UNIFORM RESOURCE LOCATOR FILTERING”, the disclosure of which is incorporated herein by reference.

### TECHNICAL FIELD OF THE INVENTION

The present invention relates generally to computer programming and more particularly to a system and method for searching a signature set for a target signature.

### BACKGROUND OF THE INVENTION

In computer programming, a data structure, such as a tree data structure may be used for organizing related pieces of information. A tree data structure is a type of data structure in which each element is attached to one or more elements directly below it. The connections between elements are called branches. Trees are often called inverted trees because they are normally drawn with the root at the top. Typically, the elements at the very bottom of an inverted tree (that is, elements that have no other elements below them) are called leaves.

One well known tree structure is a binary tree which is a special type of inverted tree in which each element has only two branches directly below it. Another known tree structure is a digital search tree. A digital search tree is a special type of inverted tree in which each element has one or more branches directly below it.

Existing computer programming languages such as C or C++ provide various functions for performing string comparisons, such as strstr, strcmp, and strspn. The strstr function returns a pointer to the first occurrence of a character set in a character string. The strcmp function indicates the lexicographic relation of two character strings. The syntax for the strspn function is “size_t strspn(const char *string1, const char *strCharSet)”. The strspn function returns an integer value specifying the length of the substring in string1 that consists entirely of characters in strCharSet.

Each time one of these functions is called, only a single character string is processed or searched. Thus, in order to search or process multiple character strings, multiple calls to one or more of these functions has to be made, thereby wasting substantial system resources. This problem is exacerbated as the number of character strings becomes larger.

### SUMMARY OF THE INVENTION

In accordance with an embodiment of the present invention, a lexical search tree data structure is disclosed. The lexical search tree data structure comprises a plurality of linked root nodes. The lexical search tree data structure also comprises at least one branch linked to at least one of the plurality of root nodes. Each branch along with the root node to which it is linked represents at least one of a plurality of signatures. A first character of each signature is represented by one of the plurality of root nodes. Each branch has one or more leaf nodes linked hierarchically to one another, each leaf node representing a character in a signature.

In accordance with another embodiment of the present invention, a method for searching a plurality of signatures stored in a lexical search tree data structure is disclosed. The method comprises determining a hash value for a target signature; determining a branch associated with a root node of the lexical search tree data structure corresponding to the hash value, the branch along with the root node representing at least one signature of the plurality of signatures, the branch having one or more leaf nodes linked hierarchically to one another, each leaf node representing an element of the at least one signature; and traversing only the branch to find a match between the at least one signature and the target signature.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a diagram of an exemplary lexical search tree data structure according to a preferred embodiment of the present invention;

FIG. 2 shows a lexical search tree data structure for an exemplary signature set;

FIGS. 3A-3C are flowcharts of a method for storing multiple strings in a lexical search tree data structure according to a preferred embodiment of the present invention; and

FIG. 4 is a flowchart of a method for searching the lexical search tree data structure according to a preferred embodiment of the present invention.

### DETAILED DESCRIPTION OF THE DRAWINGS

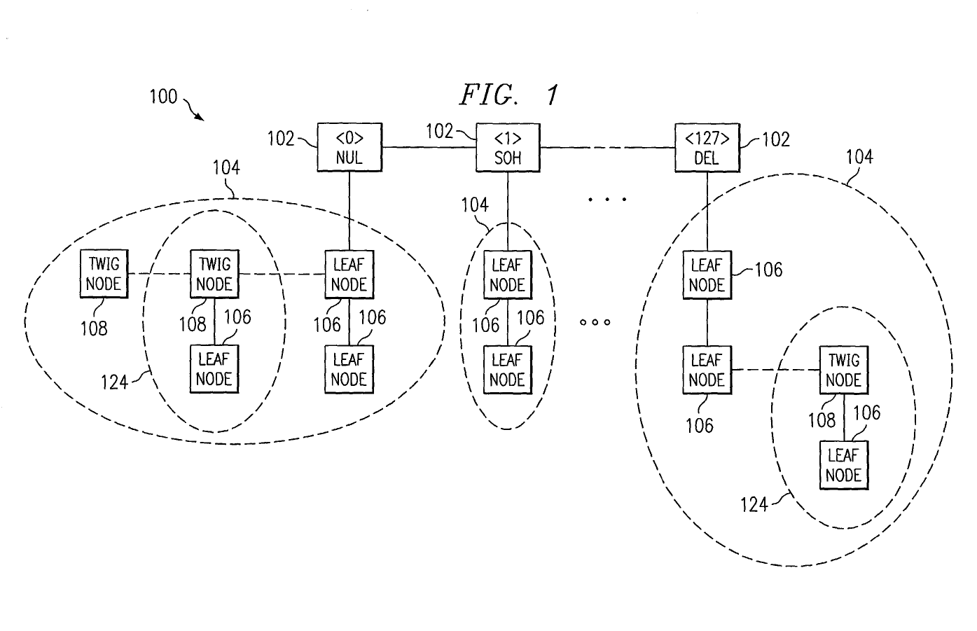

The preferred embodiment of the present invention and its advantages are best understood by referring to FIGS. 1 through 4 of the drawings, like numerals being used for like and corresponding parts of the various drawings.

A system and method for searching a signature set, such as a plurality of character strings, for a target signature, such as a target character string, while reducing the number of comparisons are disclosed.

In the preferred embodiment, a lexical search tree data structure is used to store the data to be searched in a structured and organized way. The data may represent a plurality of signatures of a signature set. The lexical search tree data structure may be implemented in software or hardware. For example, object-oriented programming techniques may be used to implement the lexical search tree data structure. Comparisons between the target signature and the data stored in the lexical search tree are performed to determine whether the lexical search tree data includes the target signature. In the preferred embodiment, this may be accomplished by scanning the target signature only once for comparison with the signature(s) in the signature set instead of scanning it multiple times for comparison with multiple signatures.

A signature may comprise a character string. A character string comprises of one or more characters. Preferably, the characters that may be used in the character strings correspond to the ASCII (American Standard Code for Information Interchange) character set which includes 128 characters, each of which may be denoted by a number from 0 to 127. However, if desired, characters from other types of character sets, such as EBCDIC (Extended Binary-Coded Decimal Interchange Code), extended ASCII, and/or the like, may be in the character strings.

FIG. 1 is a diagram of an exemplary lexical search tree data structure 100 according to a preferred embodiment of the present invention. Lexical search tree 100 comprises a plurality of root nodes 102 and a plurality of branches 104. Preferably, the number of root nodes 102 in lexical search tree 100 is equal to the total number of characters in the character set used to represent the character strings. Each root node preferably corresponds to a character from the character set. Each of the root nodes 102 includes a hash value for a particular character in the character set. Thus, when characters from the ASCII character set are used in the character strings, the total number of root nodes 102 in lexical search tree 100 is 128. On the other hand, when characters from the extended ASCII character set are used in the character strings, the total number of root nodes 102 in lexical search tree 100 is 256.

Each branch 104 is associated with at least one root node 102. A branch 104 in lexical search tree 100 comprises one or more leaf nodes 106. Branch 104 may also comprise one or more twigs 124. A twig 124 comprises a twig node 108. Twig 124 may also comprise one or more leaf nodes 106. A leaf node 106 is a continuation of a branch 104 or a twig 124 at the next lower level. A twig 124 is a divergence of a branch 104 at a leaf node 106. A twig node 108 is typically the first node of twig 124. Twig node 108 and the leaf node 106 from which it diverges are at the same level in lexical search tree 100. In the FIGURES, a link between a twig node 108 and a leaf node 106 from which it diverges is shown by dotted lines. A leaf node may have multiple twig nodes at the same level as the leaf node. However, in the embodiment illustrated in FIG. 1, a leaf node only has one other leaf node directly linked to it at the next lower level.

Each leaf node 106 and each twig node 108 may be represented by a data object that includes a value field, a leaf node pointer field and a twig node pointer field. The value field contains the character represented by the node. The leaf node pointer field contains a pointer to a leaf node at the next lower level, if any. The twig pointer field contains a pointer to a twig node at the same level, if any.

A branch along with its corresponding root node represents one or more signatures having a common first character. The common first character in each signature is represented by root node 102 and the other characters in each signature are stored in leaf nodes 106 and/or twig nodes 108. Twig 124 is a substring of a signature whose first character is represented by the corresponding root node. The first character of the substring is stored in the corresponding twig node 108.

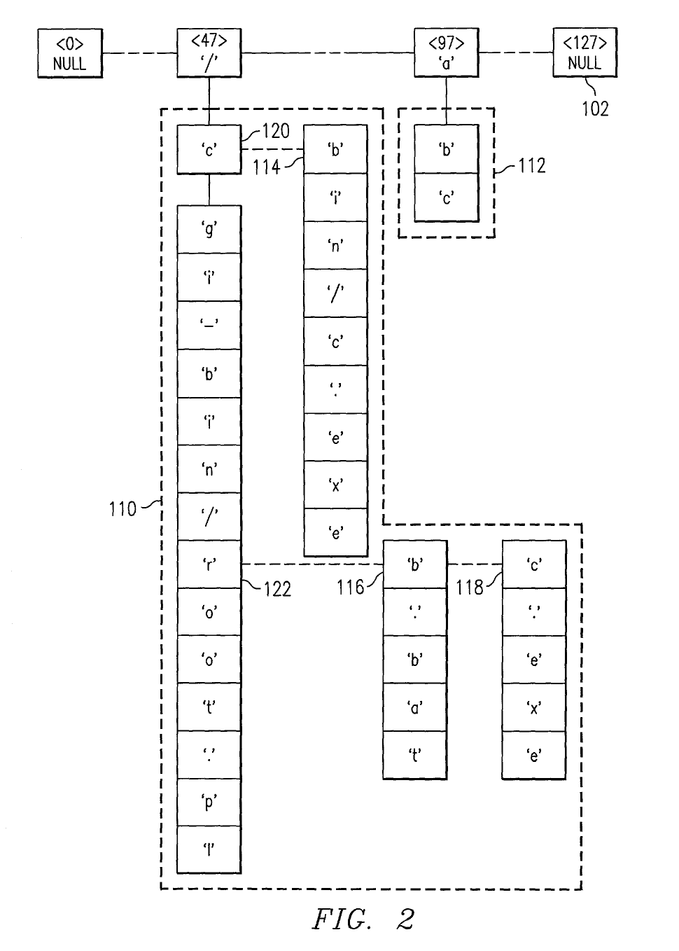

FIG. 2 shows a lexical search tree for an exemplary signature set. The exemplary signature set of FIG. 2 includes five character strings:

character string 1: “/cgi-bin/root.pl”

character string 2: “/cgi-bin/b.bat”

character string 3: “/cgi-bin/c.exe”

character string 4: “/bin/c.exe”

character string 5: “abc”

The lexical search tree of FIG. 2 includes 128 root nodes, each root node corresponding to a character in the ASCII character set. The five character strings have the characters ‘/’ and ‘a’ as the first character. The hash value for ‘/’ is 47 and the hash value for ‘a’ is 97. Therefore, in the lexical search tree the root nodes 102 corresponding to the hash value of those two characters do not have NULL pointers. All other root nodes have NULL pointers indicating that there are no character strings in the signature set that have the characters corresponding to those root nodes as the first character.

For character string 5, the next character ‘b’ is stored in a leaf node at the next lower level to the root node corresponding to ‘a’. The last character ‘c’ in character string 5 is stored in a leaf node at the next lower level than the leaf node for character ‘b’. Therefore, branch 112 along with the root node for ‘a’ to which branch 112 is linked represents character string 5.

Since ‘/’ is the first character for character strings 1 through 4, branch 110 along with the root node for ‘/’ to which branch 110 is linked represents character strings 1 through 4. The leaf nodes in branch 110 are populated in a similar manner to the leaf nodes of branch 112. Furthermore, as the first character of character string 1 and character string 4 are the same but the second character of the two character strings are different, node 114 storing character ‘b’ of character string 4 is designated as a twig node as character string 4 diverges from character string 1 at leaf node 120. Similarly, nodes 116 and 118 are designated as twig nodes as character string 2 and character string 3 both diverge from character string 1 at leaf node 122.

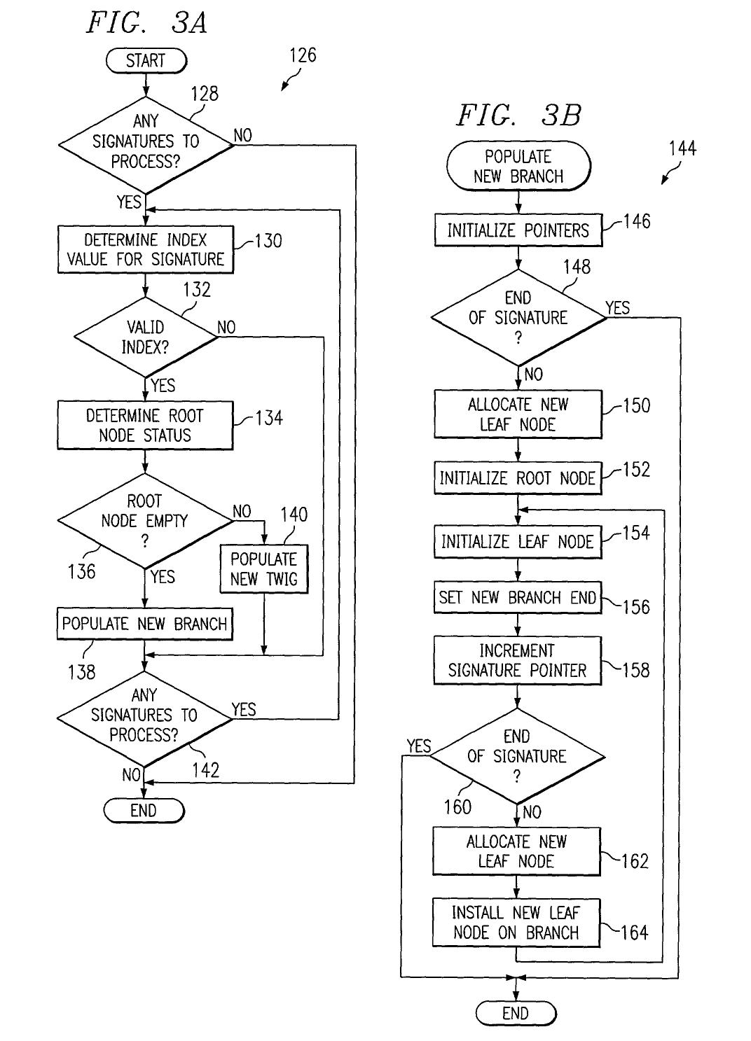

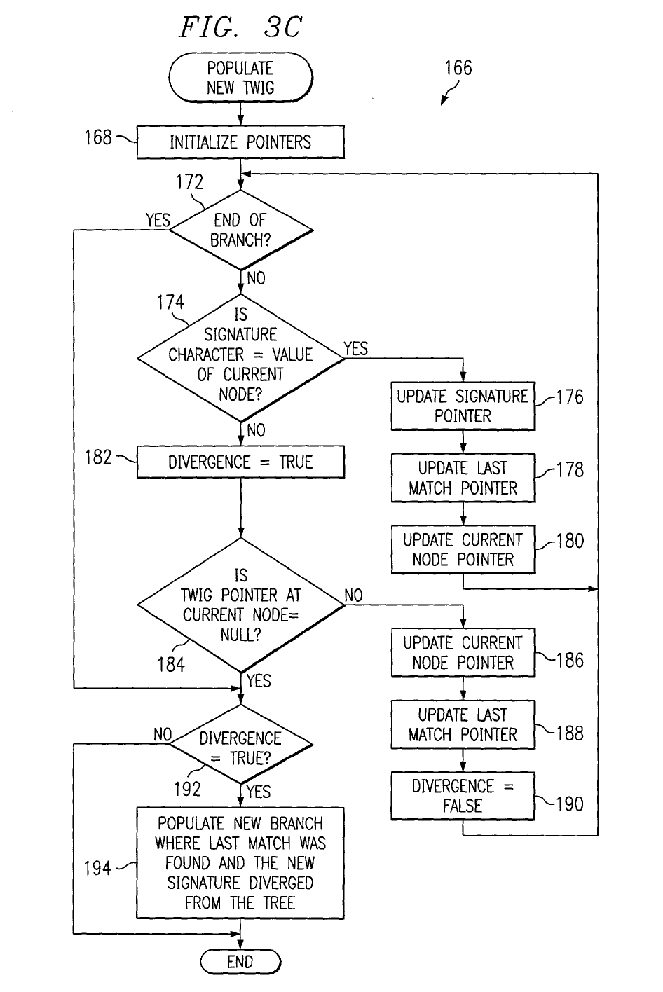

FIG. 3A is a flowchart 126 of a method for storing multiple signatures in a lexical search tree data structure according to a preferred embodiment of the present invention. In step 128, a determination is made as to whether there are any signatures in the signature set to be processed. If there is at least one more signature to be processed, then in step 130 an index value for the next signature to be processed is determined. This may be done, for example, by determining the first character of the signature and determining its hash value. Preferably, the hash value for a character corresponds to its ASCII code value when the character set is the set of ASCII characters. In step 132 the validity of the index value is determined. An index value which is within a predefined set of values is a valid index value. For example, when the character set is the set of ASCII characters, then a value between 0 and 127 is a valid index value.

In step 134, the status of the root node corresponding to the determined index value is determined. This is preferably accomplished by looking up the status of the root node in an index table. The index table includes a hash value for each character in the character set and its corresponding status information. Status information preferably includes information as to whether the root node is empty or not. A root node is considered empty if no other signatures with the same first character as the signature being processed have been stored in the lexical search tree. Status information may also include a pointer to a leaf node linked to the root node. If the root node is empty, then the leaf node pointer is NULL. In step 136, a determination is made as to whether the root node is empty. If the root node is empty then in step 138 a new branch is populated as discussed in more detail with reference to FIG. 3B. If the root node is not empty then in step 140 a new twig is populated as discussed in more detail with reference to FIG. 3C. In step 142, a determination is made as to whether there are any more signatures to be processed. If there are more signatures to be processed then the process starting at step 130 is repeated.

FIG. 3B is a flowchart 144 for populating a branch of the lexical search tree according to a preferred embodiment of the present invention. In step 146, one or more pointers, such as a current node pointer, a signature pointer, and/or the like are initialized. The current node pointer is preferably initialized to NULL. The signature pointer is preferably initialized to point to the second character in the signature being processed. In step 148, a determination is made as to whether the end of signature has been reached. If the end of signature has not been reached, then in step 150, a leaf node is allocated. As mentioned above, each leaf node includes a value for the node, a leaf node pointer and a twig node pointer. In step 152, the root node is initialized. Preferably, the root node pointer is set to point to the allocated leaf node. In step 154, the allocated leaf node is initialized. Preferably, in this step the value of the character pointed to by the signature pointer is stored in the leaf node. Furthermore, the leaf node pointer and the twig node pointer are set to NULL.

In step 156, the end of the branch from the root node corresponding to the first character of the signature being processed is set to point to the allocated leaf node, preferably by setting the current node pointer to point to the allocated leaf node. In step 158, the signature pointer is incremented to point to the next character in the signature. In step 160, a determination is made as to whether the end of the signature has been reached. If the end of signature has not been reached then in step 162, a new leaf node for the next character is allocated. In step 164, the allocated leaf node is installed on the branch, preferably by setting the leaf node pointer of the current node to point to the allocated leaf.

FIG. 3C is a flowchart 166 for populating a twig of the lexical search tree according to a preferred embodiment of the present invention. The method of populating a twig comprises determining the leaf node where the signature being processed diverges from another signature in the lexical search tree with a common first character and creating a twig for the non-matching substring from there.

In step 168, one or more pointers, such as a current node pointer, a signature pointer, a last match pointer and/or the like are initialized. The current node pointer is preferably initialized to point to the root node. The last match pointer is preferably initialized to point to the current node.

In step 172, a determination is made as to whether the current node pointer value is NULL. If the current node pointer value is not NULL, then in step 174, a determination is made as to whether the value of the character pointed to by the signature pointer is equal to the value of the current node. If the two values are the same then it indicates that there is no divergence. In step 176, the signature pointer is updated, preferably to point to the next character in the signature. In step 178, the last match pointer is updated, preferably to point to the current node. In step 180, the current node pointer is updated preferably to point to the next node, thereby making the next node the current node. Thus, in steps 178 and 180, the last match pointer is updated to point to the current node and the current node pointer is updated to point to the next node in the lexical search tree.

If in step 174, a determination is made that the value of the character pointed to by the signature pointer is not equal to the value of the current node, then in step 182, a divergence flag is set indicating that the current signature and the signature already stored in the lexical search tree diverge. In step 184, a determination is made as to whether the twig pointer of the node pointed to by the last match pointer is equal to NULL. A twig pointer value that is not NULL indicates that there are other twigs that diverge from the current node. In step 186, the current node pointer is updated preferably to point to the twig of the node pointed to by the last match pointer. In step 188, the last match pointer is updated to point to the current node. In step 190, the divergence flag is reset. The process starting at step 172 is then repeated.

A determination in step 172 that the current node pointer value is NULL indicates that the last node of the lexical search tree has been reached. In step 192 a determination is made as to whether the divergence flag, which indicates a divergence between the signature being processed and a signature having at least the same first character as the signature being processed, is set. If the divergence flag is set, then in step 194, a new branch is populated starting from the node where the last match was found and the signature to be inserted diverged from the lexical search tree. For this purpose, the method described with reference to FIG. 3B for populating a branch of the lexical search tree may be used, if desired.

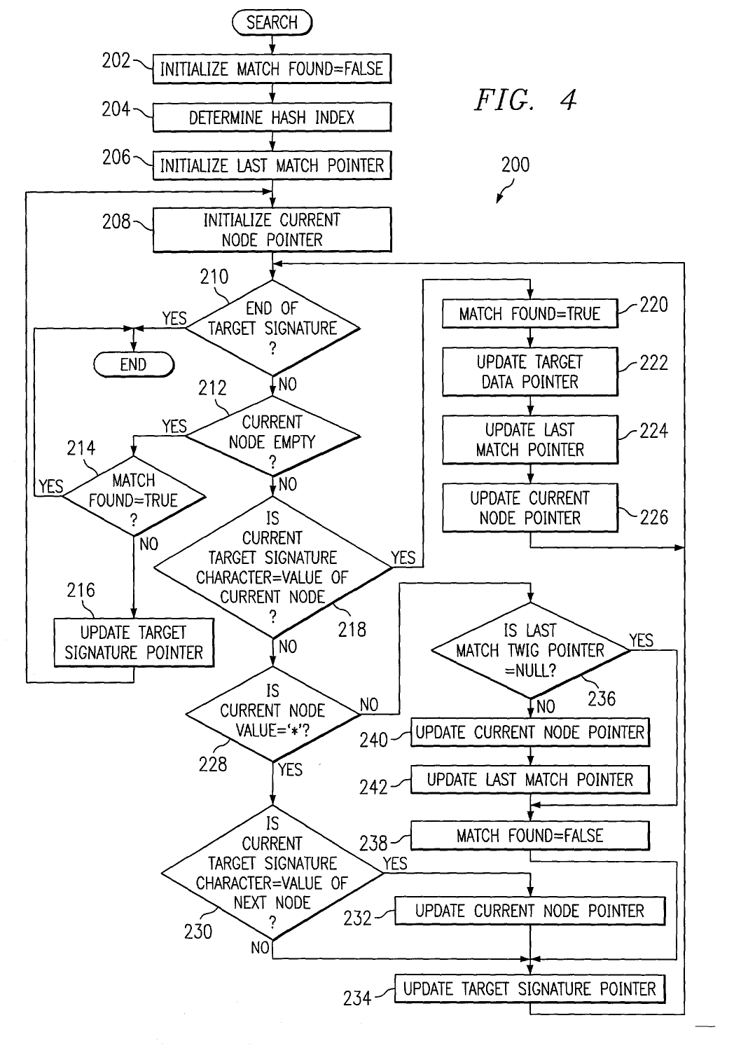

FIG. 4 is a flowchart of a method for searching a lexical search tree data structure for a target signature according to a preferred embodiment of the present invention. In step 202, a Match Found flag is reset to indicate no match. In step 204, a hash index for the search character string is determined. Preferably, the hash index is the ASCII code for the first character in the target character string. In step 206, a last match pointer is initialized preferably to point to the root node corresponding to the first character in the target character string. This may be done, for example, by initializing the last match pointer to point to the entry in the index table for the determined hash value. In step 208, a current node pointer is initialized, preferably to point to the root node corresponding to the first character in the target character string. Also, if desired, a signature pointer may be initialized, preferably to point to the first character in the target signature.

In step 210, a determination is made as to whether the end of the target signature has been reached. If the end of the target signature has not been reached then in step 212, a determination is made as to whether the current node is empty. A NULL value for the current node pointer may indicate an empty current node. If the current node is not empty then in step 218, a determination is made as to whether the value of the current node is equal to the value of the character pointed to by the target signature pointer. If the current node value is equal to the value of the character pointed to by the target signature pointer, then in step 220, the Match Found flag is set indicating a match. In step 222, the target signature pointer is updated, preferably to point to the next character in the target signature. In step 224, the last match pointer is updated, preferably to point to the current node. In step 226, the current node pointer is updated, preferably to point to the next node, thereby making the next node the current node. Thus, in steps 224 and 226, the last match pointer is updated to point to the current node and the current node pointer is updated to point to the next node in the lexical search tree.

If in step 212 it is determined that the current node is empty, then in step 214 a determination is made as to whether the Match Found flag is set. If the Match Found flag is set, then this along with the other conditions discussed above indicates that a match was found between the target signature and a signature in the lexical search tree. If Match Found is not set, then in step 216, the target signature pointer is updated, preferably to point to the next character in the target signature and the operation starting at step 208 is repeated.

A signature in the lexical search tree may include a wild card character, such as an asterisk. An exemplary signature including a wild card character may look like “abc*.exe”. The preferred embodiment of the present invention allows wild card character processing. Thus, if the target signature is “abcdefg.exe” an exact match for the target signature may not be found in the lexical search tree. However, because in a preferred embodiment, the present invention allows wild card processing, in the above example the result of the search of the lexical tree would indicate that a match was found.

If in step 218, a determination is made that the value of the current node is not equal to the value of the character pointed to by the target signature pointer, then in step 228, a determination is made as to whether the current node value is equal to the value of the wild card character. In step 230, a determination is made as to whether the value of the character pointed to by the target signature pointer is equal to the value of the next node, i.e. the leaf node of the current node. In step 232, the current node pointer is updated preferably to point to the leaf node of the next node, thereby making the leaf node of the next node the current node. In step 234, the target signature pointer is updated, preferably to point to the next character in the target signature and the process starting at step 210 is repeated.

If in step 228, it is determined that the current node value is not equal to the wild card character, then the twigs starting at the current node are searched. In step 236, a determination is made as to whether the twig pointer of the node pointed to by the last match pointer is equal to NULL. A twig pointer value that is not NULL indicates that there are twigs that diverge from the node. In step 240, the current node pointer is updated, preferably to point to the twig node of the node pointed to by the last match pointer. In step 242, the last match pointer is updated, preferably to point to the current node. In step 238, the Match Found flag is reset and the process starting at step 234 is repeated.

The hashing technique used in the preferred embodiment allows easy identification of the root node in the lexical search tree which corresponds to the first character of the target signature. Thus, all the root nodes do not have to be searched to determine if there is a match between the first character of the target signature and the first character of any of the signatures represented by the lexical search tree.

A single scan of the target signature enables determination of whether the target signature matches any of a plurality of signatures which are represented by the lexical search tree. Moreover, in the preferred embodiment of the present invention wild card searching is supported thereby reducing the number of signatures that need to be stored in the lexical search tree.

Embodiments of the present invention, or parts thereof, may be stored on a storage medium. The storage medium may have stored thereon instructions which can be used to program a computer to perform the methods according to the present invention. The storage medium may be part of the computer or may be separate from the computer and may include, but is not limited to, any type of disk including floppy disks, optical disks, CD-ROMS, DVDs, magneto-optical disks, ROMs, RAMs, EPROMs, EEPROMs, or any type of media suitable for storing electronic instructions.

What is claimed is:

1. A lexical search tree data structure, comprising:
a plurality of linked root nodes;
at least one branch linked to at least one of said plurality of root nodes, each branch along with the root node to which it is linked representing at least one of a plurality of signatures, a first character of each signature being represented by one of said plurality of root nodes; and
each branch having one or more leaf nodes linked hierarchically to one another, each leaf node representing a character in a signature.

2. The lexical search tree data structure of claim 1, further comprising a twig linked to one of said leaf nodes and representing a substring of a second signature of said plurality of signatures, said second signature having at least the same first character as said first signature and said first and second signatures diverging from one another at said leaf node to which said twig is linked.

3. The lexical search tree data structure of claim 2, said twig comprising:
a twig node representing a first character of said substring, said twig node being at the same level as said leaf node to which said twig is linked; and
one or more leaf nodes, each leaf node representing a character of said substring.

4. The lexical search tree data structure of claim 1, wherein each of said plurality of signatures comprises a string of characters.

5. The lexical search tree data structure of claim 1, wherein the number of said root nodes is equal to the number of characters in a character set available to represent said plurality of signatures.

6. The lexical search tree data structure of claim 5, wherein said character set comprises the set of ASCII characters.

7. The lexical search tree data structure of claim 1, each root node comprising a hash value for the character represented by said root node.

8. The lexical search tree data structure of claim 7, each root node further comprising a pointer to a leaf node of said one or more leaf nodes if a first character of any of said plurality of signatures corresponds to said root node.

9. The lexical search tree data structure of claim 1, each leaf node having only one other leaf node directly linked to it at the next lower level.

10. The lexical search tree data structure of claim 1, further comprising a plurality of twigs linked to one of said leaf nodes, each twig of said plurality of twigs representing a substring of a different signature of said plurality of signatures.

11. A method for searching a plurality of signatures stored in a lexical search tree data structure, said method comprising:
determining a hash value for a target signature;
determining a branch associated with a root node of said lexical search tree data structure corresponding to said hash value, said branch along with said root node representing at least one signature of said plurality of signatures, said branch having one or more leaf nodes linked hierarchically to one another, each leaf node representing an element of said at least one signature; and
traversing only said branch to find a match between said at least one signature and said target signature.

12. The method of claim 11, said determining a hash value comprising:
determining a first element of said target signature; and
determining a hash value for said first element.

13. The method of claim 12, said hash value being the ASCII code for said first element.

14. The method of claim 11, said traversing only said branch comprising comparing successive elements of said target signature with successive elements of said at least one signature stored in successive leaf nodes of said one or more leaf nodes so long as said successive elements of said target signature match said successive elements of said at least one signature.

15. The method of claim 11, said traversing only said branch further comprising:
determining a twig associated with said branch at a point of divergence between said at least one signature and said target signature, said twig representing a terminating substring of a second signature of said plurality of signatures; and
traversing said twig to find a match between a terminating substring of said target signature and said terminating substring represented by said twig.

16. The method of claim 15, said traversing said twig comprising comparing successive elements of said terminating substring of said target signature with successive elements of said terminating substring of said second signature represented by said twig so long as said successive elements match.

17. The method of claim 14, said traversing only said branch further comprising:
setting a current node pointer to point to a leaf node of said one or more leaf nodes;
setting a target signature pointer to point to an element of said target signature;
in response to a value of said leaf node pointed to by said current node pointer being equal to a wild card character and a value of the element pointed to by said target signature pointer being equal to a value of the next leaf node following the leaf node pointed to by said current node pointer, updating said current node pointer to point to a leaf node following said next leaf node.

18. A method for representing a plurality of signatures in a lexical search tree data structure, comprising:
a) allocating a plurality of root nodes, one for each distinct element of said plurality of signatures;
b) determining an index value for a signature of said plurality of signatures;
c) determining a status of a root node corresponding to said determined index value, said root node being selected from said plurality of root nodes and representing a first element of said signature;
d) creating a branch for said root node if said root node has no existing branch, said branch having one or more leaf nodes linked hierarchically to one another, each successive leaf node representing a successive element of said signature;
e) creating a twig for said root node if said root node has an existing branch, said twig linked to one of said leaf nodes and representing a substring of said signature, the first element of said substring being represented by a twig node linked to said one of said leaf nodes; and
f) repeating steps (b) through (e) for each signature of said plurality of signatures.

19. The method of claim 18, said determining index value comprising:
determining a first element of said signature; and
determining an ASCII code for said first element.

20. The method of claim 18, said creating said twig comprising: determining the location of said one of said leaf nodes from which said twig diverges.
